(19) United States
(12) Patent Application Publication
(10) Pub. No.: US 2024/0215540 A1
(43) Pub. Date: Jul. 4, 2024

(54) Device and method for controlling pet behavior

(71) Applicant: Zhongshan Great-pet internationl Co., LTD, Zhongshan (CN)

(72) Inventor: Yin Lin, Zhongshan (CN)

(21) Appl. No.: 18/312,721

(22) Filed: May 5, 2023

(30) Foreign Application Priority Data
Dec. 31, 2022 (CN) 202211736217.X

(51) Int. Cl. A01K 15/02; A01K 27/00

(52) U.S. Cl. CPC A01K 15/022; A01K 15/029; A01K 27/009

(57) ABSTRACT

A device for controlling pet behavior includes a wearable member for being worn on a body of a pet, a control mechanism disposed on the wearable member, conductive posts arranged on the wearable member, and electrically connected to the control mechanism. The conductive posts contact the body of the pet when the pet wears the wearable member, so that when the control mechanism sends an electronic pulse signal of a preset specific voltage to the conductive posts, the electronic pulse signal is conducted to the body of the pet so as to stimulate the muscles of the pet to contract, and further enabling the pet to stop barking.

### FIELD OF THE INVENTION

The disclosure relates to pet products, and more particularly pertains to a device and a method for controlling pet behavior.

### BACKGROUND OF THE INVENTION

With the improvement of people's living standards, the concern degree on pet living quality is also increasing, and more and more people regard pets as members of their families. However, pets sometimes have difficulty in controlling their skymnastics, and pets' barks often interfere with people's normal life, and also cause the owners to fall into potential compromises of complaints by neighbors; therefore, people have invented a product bark stopper capable of stopping pets from barking.

Chinese Patent Application Publication No. CN113475422A discloses a pet bark stopper and a control method thereof, comprising a conductive band and a bark-stopping device adjustably mounted on the conductive band, and further comprising a soft conductive brush and a bark-stopping control circuit, the soft conductive brush is mounted on an inner side of the bark stopping device and passes through it, and is used for contacting with a pet when the pet wears the pet bark stopper. The bark-stopping control circuit is provided in the bark-stopping device and is electrically connected to both the soft conductive brush and the conductive band, and is used for transmitting an electronic pulse signal of a preset specific voltage to the soft conductive brush and the conductive band, the electronic pulse signal being conducted to the body of the pet via the soft conductive brush. The soft conductive brush on the inner side of the bark-stopping device stimulates the muscle and the meridian of the pet in the form of an electronic pulse signal so that the pet stops barking.

Although the pet bark stopper can achieve the effect of stopping barking to a certain degree, its soft conductive brush is thin and cannot effectively conduct electronic pulse signals, resulting in a poor control effect on the pet's behavior. Therefore, it is necessary to improve the prior art to solve the described problems.

### SUMMARY OF THE INVENTION

An objective of the disclosure is to provide a device and a method for controlling pet behavior to solve the technical problem in the prior art that the soft conductive brush of the assembly for modifying pet behavior is thin and cannot effectively conduct electronic pulse signals, resulting in a poor control effect.

To achieve the above objective, an embodiment of the disclosure provides a device for controlling pet behavior, which includes a wearable member for being worn on a body of a pet, a control mechanism disposed on the wearable member, conductive posts arranged on the wearable member and electrically connected to the control mechanism. The conductive posts are used for contacting the body of the pet when the pet wears the wearable member so that when the control mechanism sends an electronic pulse signal of a preset specific voltage to the conductive posts, the electronic pulse signal is conducted to the body of the pet.

Optionally, the number of the conductive posts is multiple, each of the conductive posts comprises a connecting post and a contact, a bottom of the connecting post is connected to the wearable member, and a top of the connecting post is connected to a bottom of the contact.

Optionally, an internal cavity is further provided between the connecting post and the contact.

Optionally, a conductive medium is provided in each of the conductive posts, so that the electronic pulse signal is conducted to the body of the pet through the conductive medium in the conductive posts so that the muscle of the pet contracts and flutters.

Optionally, the device for controlling pet behavior also includes a remote controller in communication connection with the control mechanism, and being used for instructing the control mechanism to transmit the electronic pulse signal of the preset specific voltage to the wearable member and the conductive posts.

Optionally, the control mechanism is provided with a power supply circuit and a control signal collection circuit, a main control circuit, and a pulse output circuit all electrically connected to the power supply circuit, wherein the control signal collection circuit is configured to collect a behavior control signal; the main control circuit is electrically connected to the control signal collection circuit and is used for acquiring a behavior control signal, and generating a pulse transmission signal according to the behavior control signal; the pulse output circuit being electrically connected to all of the main control circuit, the conductive posts and the wearable member, and being used for transmitting the electronic pulse signal of the preset specific voltage to the conductive posts according to the pulse transmission signal, so that the electronic pulse signal is conducted to the body of the pet via the conductive posts.

Optionally, the control signal collection circuit includes a sound monitoring circuit electrically connected to the main control circuit and used for acquiring a predetermined sound signal so that the pulse output circuit emits the electronic pulse signal of the preset specific voltage to the conductive posts.

Optionally, the control signal collection circuit includes a wireless control receiving circuit electrically connected to the main control circuit and used for collecting a wireless remote control signal sent by a user via a remote controller.

Optionally, the power supply circuit includes a charging management circuit and a rechargeable battery, the charging management circuit is configured to connect to an external power supply device, and the rechargeable battery is electrically connected to all of the charging management circuit, the control signal collection circuit, the main control circuit, and the pulse output circuit.

Optionally, the wearable member is a foot sleeve, an upper end thereof is open, and the foot sleeve is used for wrapping a foot of the pet; the conductive posts are uniformly distributed on an inner surface of the foot sleeve; and the control mechanism is fixed on the foot sleeve.

Optionally, the wearable member is a band, two ends thereof are movably connected, and the band is used for surrounding and fixing on the limb of the pet; the conductive posts are uniformly distributed on the inner surface of the band; and the control mechanism is fixed on the band.

Optionally, the wearable member is a collar, two ends thereof are movably connected, and the collar is fixed to a neck of the pet; the conductive posts are uniformly distributed on an inner surface of the collar; and the control mechanism is fixed on the collar.

Optionally, the wearing member is an underwaist, two ends thereof are movably connected, and the underwaist is fixed on a torso of the pet; the conductive posts are uniformly arranged on the inner surface of the underwaist; and the control mechanism is fixed on the underwaist.

Optionally, a strap is detachably connected to the underwaist, a pulling force sensor is provided at a joint between the strap and the underwaist, and the pulling force sensor is in communication connection with the control mechanism.

Optionally, the device for controlling pet behavior also includes a signal generator in a communication connection with the control mechanism, and being used for continuously transmitting a positioning signal within a preset specific range; the control mechanism is used for receiving the positioning signal, and is used for transmitting an electronic pulse signal of a preset specific voltage to the conductive posts when the positioning signal is not received.

One or more of the described technical solutions of the device for controlling pet behavior provided by the embodiments in the disclosure have at least one of the following technical effects:

When using the device for controlling pet behavior in the disclosure, the device for controlling pet behavior is fixed on the pet's body by the wearing member, and the conductive posts on the wearing member are in contact with the pet's body. When it is required to control the pet's behaviors such as stop barking, the control mechanism transmits the electronic pulse signal of the preset specific voltage to the conductive posts, the electronic pulse signal is conducted to the pet's body so as to stimulate the muscles and envelopes of the pet, thus enabling the pet to contract the muscles under the stimulation, and further enabling the pet to stop barking. Compared with the prior art, the conductive posts in the disclosure are thicker, can better conduct a pulse signal to the pet's body, and can more effectively stimulate the muscles of the pet, so that the effect of inhibiting a behavior is better.

An embodiment of the present invention also provides a method for controlling pet behavior based on the device for controlling pet behavior. The method comprises the following steps:
Step S100: the device for controlling pet behavior is worn on the pet's body through the wearing member and the conductive posts are in contact with the pet's body;
Step S200: the control mechanism transmits the electronic pulse signal of the preset specific voltage to the conductive posts, the electronic pulse signal being conducted to the pet's body via the conductive posts, and being used for stimulating the pet's muscle to contract and tremor.

Optionally, the method also includes:
Step S300: a signal generator of the device for controlling pet behavior sends a positioning signal within the preset specific range;
Step S400: the control mechanism determines whether the positioning signal is received;
Step S500: if the determination result is no, then the control mechanism outputs the electronic pulse signal with the preset specific voltage to the conductive posts so that the electronic pulse signal stimulates the pet's muscle to contract and tremor when the pet equipped with the device for controlling pet behavior moves outside the preset specific range.

One or more of the described technical solutions of the method for controlling pet behavior provided by the embodiments in the disclosure have at least one of the following technical effects:

The method for controlling pet behavior is performed based on the device for controlling pet behavior, and therefore the method for controlling pet behavior can realize to stimulate the pet's muscle to contract and tremor so as to stop pet behavior such as barking. In the process, the conductive posts are thicker than that in the prior art so that the pulse signal can be better transmitted to the pet's body, and the pet's muscle can be stimulated more effectively, thus, the behavior control effect is better.

### BRIEF DESCRIPTION OF THE DRAWINGS

In order to more clearly illustrate the technical schemes in the embodiments in the present invention, the drawings needed in the embodiments or the prior technical description are briefly introduced below. Obviously, the drawings described below are only some embodiments of the present invention, and for those skilled in the art, additional drawings may be obtained according to the drawings below without creative work.

FIG. 1 is a perspective view of the device for controlling pet behavior according to an embodiment of the disclosure.

FIG. 2 is a sectional view of one of the conductive posts in the device for controlling pet behavior according to an embodiment of the disclosure.

FIG. 3 is a structural block diagram of a circuit on a control mechanism of the device for controlling pet behavior according to an embodiment of the present invention.

FIG. 4 is a schematic diagram of the device for controlling pet behavior in the usage state.

FIG. 5 is a perspective view of the device for controlling pet behavior according to the other embodiment of the disclosure.

FIG. 6 is a schematic diagram of the device for controlling pet behavior shown in FIG. 5 in the usage state.

FIG. 7 is a perspective view of the device for controlling pet behavior according to another embodiment of the disclosure.

FIG. 8 is a schematic diagram of the device for controlling pet behavior shown in FIG. 7 in the usage state.

FIG. 9 is a perspective view of the device for controlling pet behavior according to another embodiment of the disclosure.

FIG. 10 is a schematic diagram of the device for controlling pet behavior shown in FIG. 9 in the usage state.

FIG. 11 is a schematic diagram showing the usage state of the signal generator in the device for controlling pet behavior according to another embodiment of the disclosure.

FIG. 12 is a flowchart of the method for controlling pet behavior according to an embodiment of the disclosure.

FIG. 13 is a flowchart of the method for controlling pet behavior according to an embodiment of the disclosure.

### DETAILED DESCRIPTION OF ILLUSTRATED EMBODIMENTS

The embodiments of the present invention will be described in detail below. Examples of the embodiments are shown in the drawings, where the same or similar reference numerals throughout indicate the same or similar elements or elements having the same or similar functions. The embodiments described below by referring to the accompanying drawings are exemplary and are intended to be used to explain the embodiments of the present invention, but cannot be understood as limiting the present invention.

In the description of the embodiment of the present invention, it needs to be understood that the azimuth or position relation indicated in the terms “length”, “width”, “upper”, “lower”, “front”, “rear”, “left”, “right”, “vertical”, “horizontal”, “top”, “bottom”, “inside”, “outside” and so on are based on the azimuth or position relation shown in the attached drawing, only for the convenience of describing the embodiment of the present invention and simplifying the description, rather than indicating or implying that the device or element must have a specific orientation, with a specific orientation and operation, so it can not be understood as a limitation to the present invention.

Furthermore, the terms “first”, “second” are used only for descriptive purposes and they can not be understood as indicating or implying relative importance or implicitly the number of technical features indicated. Thus, the qualification of “first” and “second” features may include one or more of them explicitly or implicitly. In the description of the embodiments of the invention, the meaning of “multiple” is two or more, unless otherwise specified.

In the embodiment of the invention, unless other specified and qualified, the terms “installation”, “connection”, “fixed” and other terms shall be broadly understood, for example, it may be fixed connection, detachable connection, or integration; it may be a mechanical connection or an electrical connection; it may be directly connected or indirectly connected by intermediate media, it may be an internal connection of two components or the interaction of two components. For ordinary technicians in the field, the specific meaning of the above term in the embodiment of the invention can be understood according to the specific circumstances.

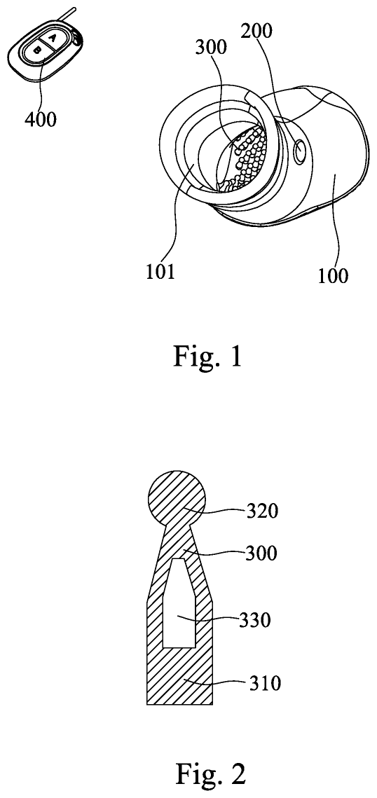

In an embodiment of the disclosure, referring to FIG. 1, it provides a device for controlling pet behavior, which includes a wearable member 100, a control mechanism 200, and conductive posts 300. The wearable member 100 is worn on a body of a pet. The control mechanism 200 is disposed on the wearable member 100. The conductive posts 300 are arranged on the wearable member 100 and electrically connected to the control mechanism 200.

The conductive posts 300 are used for contacting the body of the pet when the pet wears the wearable member 100 so that when the control mechanism 200 sends an electronic pulse signal of a preset specific voltage to the conductive posts 300, the electronic pulse signal is conducted to the body of the pet so as to stimulate the pet's muscle to contract and tremor.

In the embodiment, the conductive medium is provided in each of the conductive posts 300, so that the electronic pulse signal is conducted to the body of the pet through the conductive medium in the conductive post so that the pet's muscle contracts and tremors. The conductive medium may be made from graphene, carbon fiber, conductive rubber, and the like, and is not limited thereto, as long as the electronic pulse electrical signal can be transmitted to the pet's body. The number of the conductive posts 300 is multiple, and adjacent conductive posts 300 are disposed at equal intervals. Referring to FIG. 2, each of the conductive post 300 includes a connection post 310 and a contact 320 being integrally formed. The connection post 310 is in a conical column shape, and a bottom of the connection post 310 is connected to the wearable member 100. The contact 320 is in a spherical shape, so as to reduce the stimulation to the pet's body. A bottom of the contact 320 is connected to a top of the connection post 310, and an inner recess 330 is further provided between the connection post 310 and the contact 320 so that the conductive post 300 is more flexible, and the stimulation to the pet's body caused by wearing for a long time is reduced.

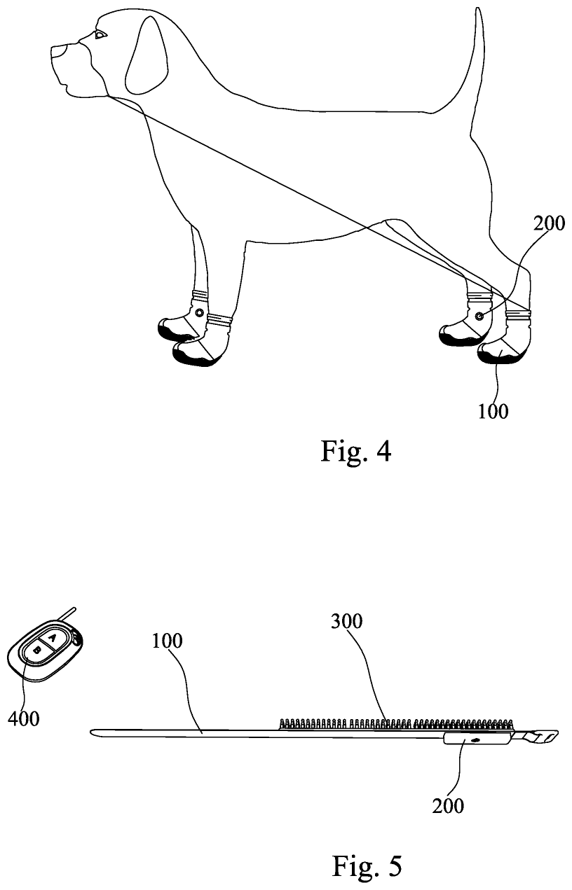

When using the device for controlling the pet behavior, referring to FIG. 4, the device for controlling the pet behavior is fixed on the pet's body through the wearable member 100, and the conductive posts 300 on the wearing member 100 are in contact with the pet's body. When it is required to control pet's behaviors such as stop barking, the control mechanism 200 transmits the electronic pulse signal of the preset specific voltage to the conductive posts 300, the electronic pulse signal is conducted to the pet's body so as to stimulate the muscles and envelopes of the pet, thus enabling the pet to contract the muscles under the stimulation, and further enabling the pet to stop barking. Compared with the prior art, the conductive posts 300 in the disclosure are thicker, can better conduct a pulse signal to the pet's body, and can more effectively stimulate the muscles of the pet, so that the effect of inhibiting a behavior is better.

It should be pointed out that the function of the device for controlling pet behavior in the disclosure is not limited to stopping barking, and includes, but not be limited to, stopping various bad behaviors of the pet such as bare its teeth, knocking, and biting, which should be understood that stopping various bad behaviors as mentioned in the disclosure have equal effect as stopping barking.

In another embodiment, the value of the preset specific voltage is set to be 50-500 V, and the output current is set to be a small current of 0-15 mA, so as to realize the output of a large voltage and a small current, thereby realizing to stop barking without damage. By setting the voltage range value, the pet can be stimulated by the electronic pulse signal based on the change of the d voltage value, thereby avoiding the problems of physical and psychological damage to the pet caused by a strong electric shock. And the nervous system of the pet is stimulated by such a weak electric pulse signal, thereby contracting the muscles of the pet, damage problems such as muscle pain will not be caused, and an effect like benign fibrillation is achieved. However, the pet will be affected, so as to achieve the purpose of stopping barking without damage and controlling pet behaviors.

The electronic pulse signal adopts a low-cycle wave mode, a weak current is applied to the pet's body in a low-frequency manner, and a multi-point contact of electrodes is used to directly stimulate muscles and intra-muscular nerve endings, so that the muscles will be unintentionally contracted. Simulating different control sensations such as beating, pulling, and the like on muscles by changing the intensity, duration, and frequency of the electronic pulse signal, thus realizing pet behavior control. In addition, the stimulation of a weak current can also promote local blood circulation, thereby helping the pet with healthy physiotherapy.

Further, different voltage values may be set for different types of pets with different volumes, and a small current may be set at the same time so that the behaviors of different pets are controlled.

In another embodiment, referring to FIG. 1, the device for controlling pet behavior also includes a remote controller 400 in communication connection with the control mechanism 200 and used for instructing the control mechanism 200 to transmit the electronic pulse signal of the preset specific voltage to the wearable member 100 and the conductive posts 300. When the pet barks or makes an attack action, the user can actively send an instruction to the control mechanism 200 via the remote controller 400 so that the control mechanism 200 transmits an electronic pulse signal, thereby enabling the pet to stop the action.

Further, for different behaviors of the pet, such as baring teeth, exploding, and biting, the remote controller 400 is set with a plurality of stimulation gears, and each thereof corresponds to a different pulse intensity to appropriately stop various behaviors of the pet.

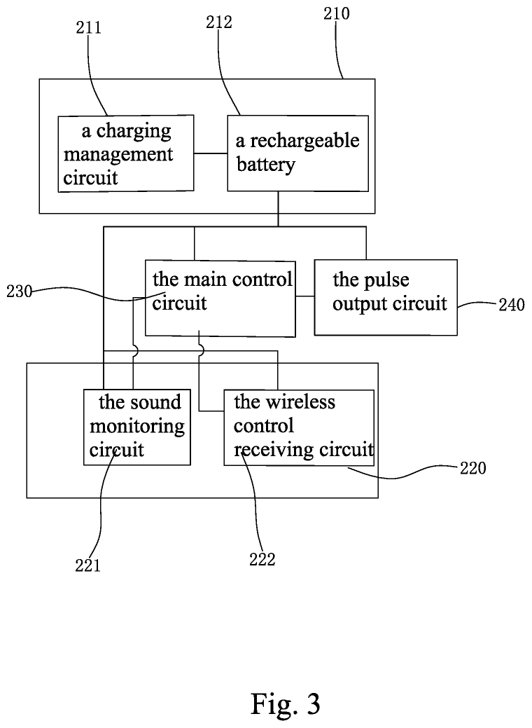

In another embodiment, referring to FIG. 3, the control mechanism 200 is provided with a power supply circuit 210 and a control signal collection circuit 220, a main control circuit 230, and a pulse output circuit 240 all electrically connected to the power supply circuit 210.

The control signal collection circuit 220 is configured to collect a behavior control signal, which comprises wireless remote control signals and pet barking sound data.

The main control circuit 230 is electrically connected to the control signal collection circuit 220 and is used for acquiring a behavior control signal and generating a pulse transmission signal according to the behavior control signal.

The pulse output circuit 240 is electrically connected to all of the main control circuit 230, the conductive posts 300, and the wearable member 100, the pulse output circuit 240 is used for transmitting the electronic pulse signal of the preset specific voltage to the conductive posts 300 and the wearable member 100 according to the pulse transmission signal, so that the electronic pulse signal is conducted to the body of the pet via the conductive posts 300.

In another embodiment, the control signal collection circuit 220 includes a sound monitoring circuit 221 electrically connected to the main control circuit 230 and used for acquiring a predetermined sound signal so that the pulse output circuit 240 emits the electronic pulse signal of the preset specific voltage to the conductive posts 300.

Specifically, the sound monitoring circuit 221 collects the pet barking sound data in real-time, if the barking sound is too loud, the main control circuit 230 generates the electronic pulse signal and sends to the pulse output circuit 240, thereby realizing automatically stopping barking when the pet barks loudly.

Or, when the sound monitoring circuit 221 receives a sound signal with a preset pitch and/or sound length, such as a user's stopping sound, the main control circuit 230 generates a pulse emission signal and sends it to the pulse output circuit 240 to actively stop the pet from barking.

In another embodiment, the control signal collection circuit 220 includes a wireless control receiving circuit 222 electrically connected to the main control circuit 230 and used for collecting a wireless remote control signal sent by a user via a remote controller. The wireless control receiving circuit 222 includes but is not limited to, Bluetooth, wifi, and a module circuit composed of a 2.4 GHZ transmitter. In this way, barking can be controlled remotely, and the using convenience is improved.

In another embodiment, the power supply circuit 210 includes a charging management circuit 211 and a rechargeable battery 212, the charging management circuit 211 is configured to connect to an external power supply device, and the rechargeable battery 212 is electrically connected to all of the charging management circuit 211, the control signal collection circuit 220, the main control circuit 230, and the pulse output circuit 240. The charging management circuit 211 is used to manage the electric energy input by external power supply devices, and at the same time protect the rechargeable battery 212, prevent the problem of overcharge and overdischarge, and improve the stability and safety of the electronic control part of the device.

In another embodiment, referring to FIG. 1, the wearable member 100 is a foot sleeve used for wrapping a foot of the pet. The foot sleeve has an accommodating cavity 101 with an open upper end so that the feet of the pet can extend in it. The open upper end of the accommodating cavity 101 is elastic to adapt to pets of different sizes. The conductive posts 300 are evenly distributed on the inner surface of the foot sleeve. The control mechanism 200 is fixed on the foot sleeve. The remote controller 400 is communicatively connected with the control mechanism 200.

When in use, referring to FIG. 4, the foot of the pet is inserted into the accommodating cavity 101, so that the foot sleeve is elastically wrapped around the foot of the pet. After receiving the behavior control signal through the control mechanism 200, the electronic pulse signal with a preset specific voltage is transmitted to the conductive posts 300, and the electronic pulse signal is transmitted to the body of the pet to stop barking.

In another embodiment, referring to FIG. 5, the wearable member 100 is a band, two ends thereof are movably connected to adapt to pets of different sizes, and the band is used for surrounding and fixing on the limb of the pet. The conductive posts 300 are uniformly distributed on the inner surface of the band. And the control mechanism 200 is fixed on the band. The remote controller 400 is communicatively connected with the control mechanism 200.

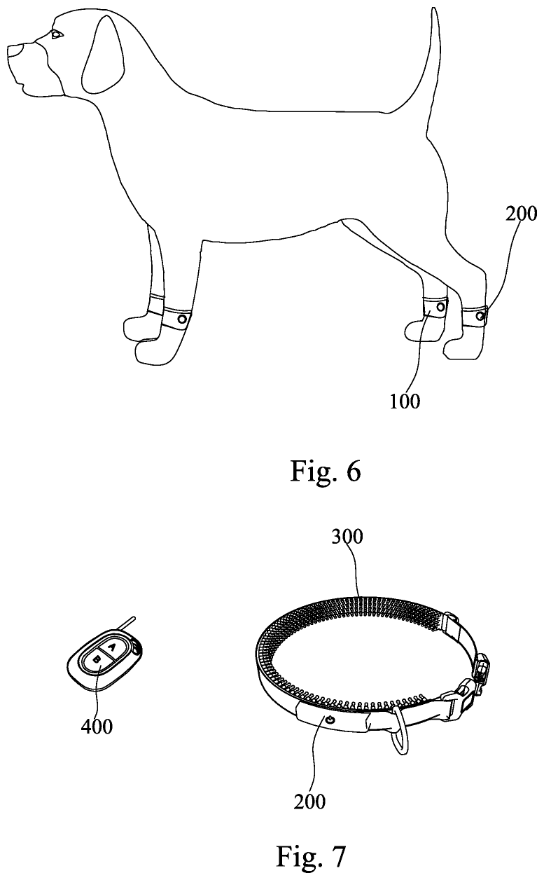

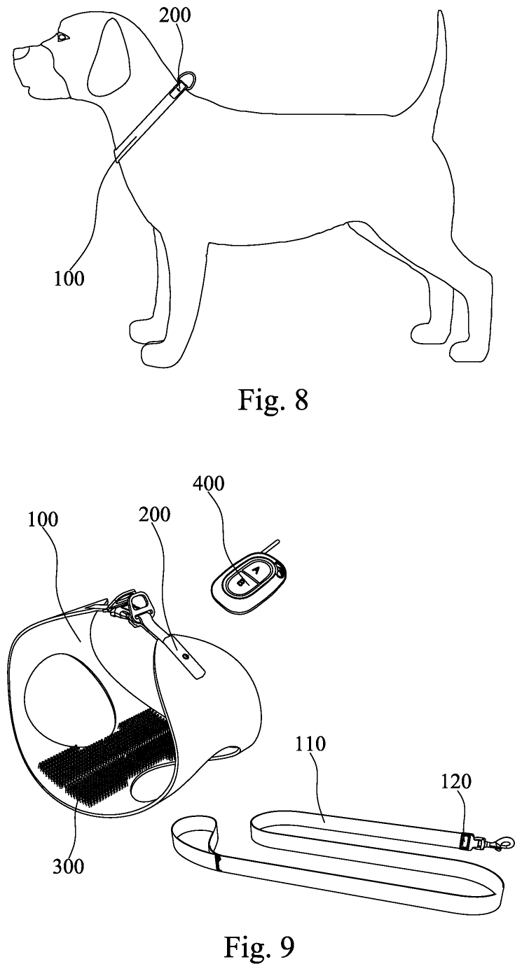

When in use, referring to FIG. 6, the band is used for surrounding and fixing on the limb of the pet, and tightening both ends of the band to fix it., after receiving the behavior control signal through the control mechanism 200, the electronic pulse signal with a preset specific voltage is transmitted to the conductive posts 300, and the electronic pulse signal is transmitted to the body of the pet to stop barking.

In another embodiment, referring to FIG. 5, the wearable member 100 is a collar, two ends thereof are movably connected to adapt to pets of different sizes, and the collar is fixed to a neck of the pet. The conductive posts 300 are uniformly distributed on an inner surface of the collar. The control mechanism 200 is fixed on the collar. The remote controller 400 is communicatively connected with the control mechanism 200.

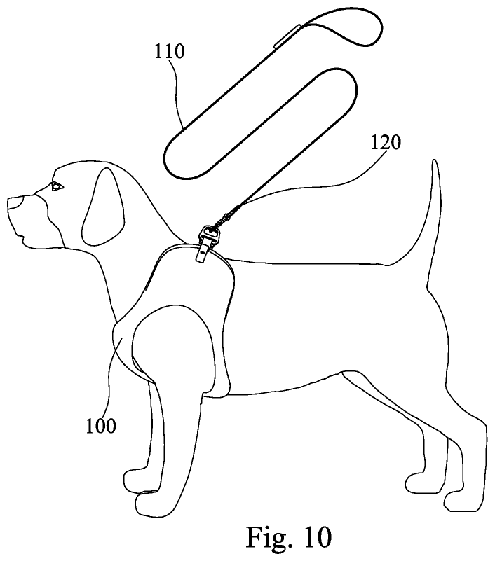

When in use, referring to FIG. 8, the collar is surrounded and the neck of the pet, tighten both ends of the band to fix it., after receiving the behavior control signal through the control mechanism 200, the electronic pulse signal with a preset specific voltage is transmitted to the conductive posts 300, and the electronic pulse signal is transmitted to the body of the pet to stop barking.

In another embodiment, referring to FIG. 9, the wearable member 100 is an underwaist, two ends thereof are movably buckled and connected, and the underwaist is fixed on a torso of the pet, and it can be fixed on the abdomen back of the pet or the chest back of the pet. The conductive posts 300 are uniformly arranged on the inner surface of the underwaist. And the control mechanism 200 is fixed on the underwaist. The remote controller 400 is communicatively connected with the control mechanism 200.

Further, a strap 110 is detachably connected to the underwaist, a pulling force sensor 120 is provided at a joint between the strap 110 and the underwaist, and the pulling force sensor 120 is in communication connection with the control mechanism 200. When the pet bursts, the tension sensor 120 sends a stop control signal to the control mechanism 200 when it obtains a tension exceeding a predetermined value, and the control mechanism 200 emits an electronic pulse signal to stimulate the pet muscle to contract to stop the action.

When in use, referring to FIG. 10, the underwaist is worn on the pet, the two ends of the underwaist are fastened and fixed, and the strap 110 is fixed on the underwaist. After receiving the behavior control signal, the control mechanism 200 transmits the electronic pulse signal with the preset specific voltage to the conductive post 300, and conducts the electronic pulse signal to the body of the pet, so that the pet stops the action.

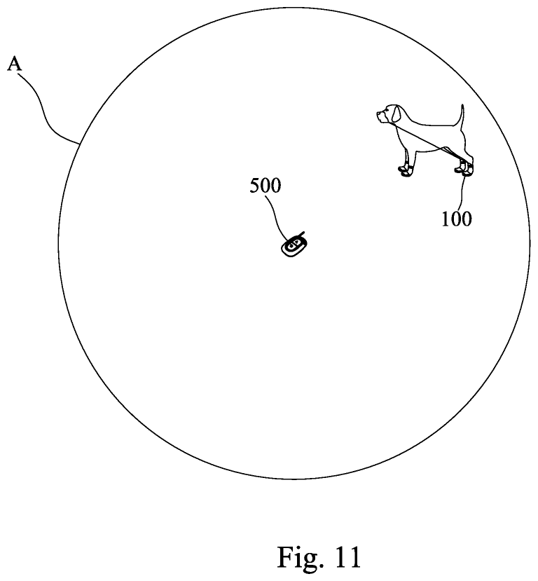

In another embodiment, referring to FIG. 11, the device for controlling pet behavior also includes a signal generator 500 being in a communication connection with the control mechanism 200, and being used for continuously transmitting a positioning signal within a preset specific range. In FIG. 11, the A indicates the preset specific range. The control mechanism is used for receiving the positioning signal and is used for transmitting the electronic pulse signal of the preset specific voltage to the conductive posts 300 when the positioning signal is not received.

When in use, the signal generator 500 communicates with the control mechanism 200 and continuously emits positioning signals. When the control mechanism 200 receives the positioning signal, it means that the pet is within the preset specific range, and the control mechanism 200 does not act; When the positioning signal is not received by the control mechanism 200, it means that the pet is out of the preset specific range, and the control mechanism 200 emits the electronic pulse signal to stimulate the pet's muscles to contract so that the pet stops moving and returns to the preset specific range. Through the above structure, pets can be effectively prevented from running around at home and damaging household items. Moreover, the user carries the signal generator 500 with him, which can prevent the pet from bursting and falling in the scene of leashing. At the same time, it can also prevent the pet from going far and avoid the loss of the pet in the scene without the rope.

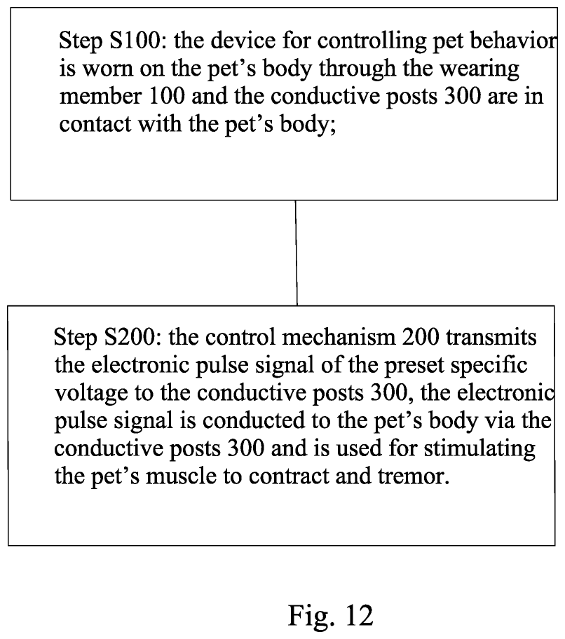

Referring to FIG. 12, an embodiment of the disclosure also provides a method for controlling pet behavior, based on the device for controlling pet behavior. The method comprises the following steps:
Step S100: the device for controlling pet behavior is worn on the pet's body through the wearing member 100 and the conductive posts 300 are in contact with the pet's body;
Step S200: the control mechanism 200 transmits the electronic pulse signal of the preset specific voltage to the conductive posts 300, the electronic pulse signal is conducted to the pet's body via the conductive posts 300 and is used for stimulating the pet's muscle to contract and tremor.

The value of the preset specific voltage is set to be 50-500 V, and the output current is set to be a small current of 0-15 mA, so as to realize the output of a large voltage and a small current, thereby realizing to stop barking without damage.

Further, different voltage values may be set for different types of pets with different volumes, and a small current may be set at the same time so that the behaviors of different pets are controlled.

The method for controlling pet behavior is performed based on the device for controlling pet behavior, and therefore the method for controlling pet behavior can realize to stimulate the pet's muscle to contract and tremor so as to stop the pet behavior such as barking. In the process, the conductive posts are thicker than that in the prior art so that the pulse signal can be better transmitted to the pet's body, and the pet's muscle can be stimulated more effectively, thus, the behavior control effect is better.

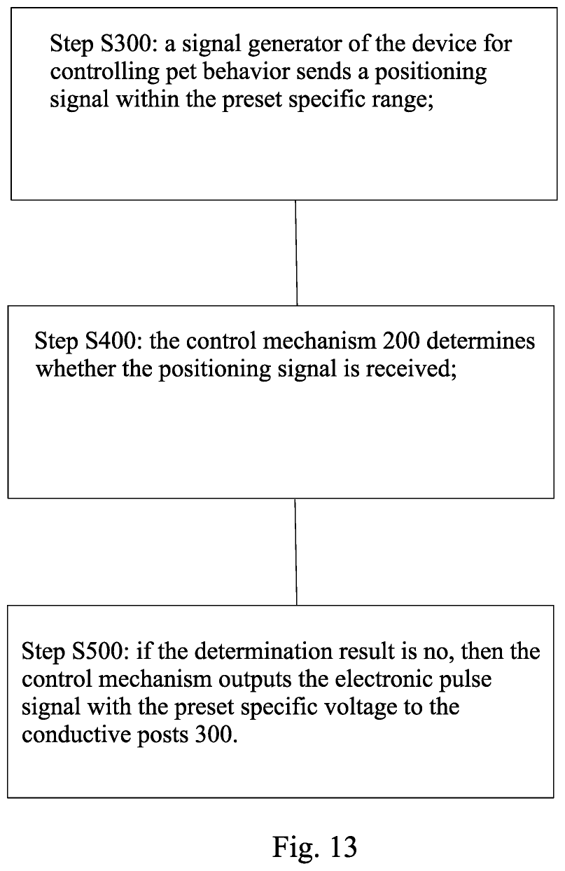

In the other embodiment, referring to FIG. 13, the method for controlling pet behavior also includes:
Step S300: a signal generator of the device for controlling pet behavior sends a positioning signal within the preset specific range;
Step S400: the control mechanism 200 determines whether the positioning signal is received;
Step S500: if the determination result is no, then the control mechanism outputs the electronic pulse signal with the preset specific voltage to the conductive posts 300.

In this embodiment, the positioning signal is generated by the signal generator of the pet behavior controller within a preset specific range, which represents the activity range of the pet. When the positioning signal is not received by the control mechanism 200, it means that the pet is out of the moving range. The control mechanism 200 sends the electronic pulse signal with the preset specific voltage to the conductive pole 300, so that the pet stops moving away and stays in the preset specific range, thus achieving the effect of an electronic fence.

The above is only the preferred embodiment of the disclosure, and it is not used to limit the disclosure. Any modification, equivalent substitution, and improvement made within the spirit and principle of the disclosure should be included in the protection scope of the disclosure.

What is claimed is:

1. A device for controlling pet behavior, comprising:
a wearable member, being worn on a body of a pet,
a control mechanism, disposed on said wearable member,
wherein also comprising conductive posts, arranged on said wearable member and electrically connected to said control mechanism, and being used for contacting said body of said pet when said pet wears said wearable member so that when said control mechanism sends an electronic pulse signal of a preset specific voltage to said conductive posts, said electronic pulse signal is conducted to said body of said pet.

2. The device for controlling pet behavior according to claim 1, wherein said conductive posts is multiple, each of said conductive posts comprises a connecting post and a contact, a bottom of said connecting post is connected to said wearable member, and a top of said connecting post is connected to a bottom of said contact.

3. The device for controlling pet behavior according to claim 2, wherein an internal cavity is further provided between said connecting post and said contact.

4. The device for controlling pet behavior according to claim 2, wherein a conductive medium is provided in each of said conductive posts, so that said electronic pulse signal is conducted to said body of said pet through said conductive medium in said conductive posts so that said muscle of said pet contracts and flutters.

5. The device for controlling pet behavior according to claim 1, wherein also comprising a remote controller being in communication connection with said control mechanism, and being used for instructing said control mechanism to transmit said electronic pulse signal of said preset specific voltage to said wearable member and said conductive posts.

6. The device for controlling pet behavior according to claim 1, wherein said control mechanism is provided with a power supply circuit and a control signal collection circuit, a main control circuit, and a pulse output circuit all electrically connected to said power supply circuit;
said control signal collection circuit is configured to collect a behavior control signal;
said main control circuit is electrically connected to said control signal collection circuit and is used for acquiring a behavior control signal and generating a pulse transmission signal according to said behavior control signal;
said pulse output circuit is electrically connected to all of said main control circuit, said conductive posts, and said wearable member, and is used for transmitting said electronic pulse signal of said preset specific voltage to said conductive posts according to said pulse transmission signal so that said electronic pulse signal is conducted to said body of said pet via said conductive posts.

7. The device for controlling pet behavior according to claim 1, wherein said control signal collection circuit includes a sound monitoring circuit electrically connected to said main control circuit and used for acquiring a predetermined sound signal so that said pulse output circuit emits said electronic pulse signal of said preset specific voltage to said conductive posts.

8. The device for controlling pet behavior according to claim 1, wherein said wearable member is a foot sleeve, an upper end thereof is open, and said foot sleeve is used for wrapping a foot of said pet; said conductive posts are uniformly distributed on an inner surface of said foot sleeve; and said control mechanism is fixed on said foot sleeve.

9. The device for controlling pet behavior according to claim 1, wherein said wearable member is a band, two ends thereof are movably connected, and said band is used for surrounding and fixing on a limb of said pet; said conductive posts are uniformly distributed on said inner surface of said band; and said control mechanism is fixed on said band.

10. The device for controlling pet behavior according to claim 1, wherein said wearable member is a collar, two ends thereof are movably connected and said collar is fixed to a neck of said pet; said conductive posts are uniformly distributed on an inner surface of said collar; and said control mechanism is fixed on said collar.

11. The device for controlling pet behavior according to claim 1, wherein said wearing member is an underwaist, two ends thereof are movably connected, and said underwaist is fixed on a torso of said pet; said conductive posts are uniformly arranged on said inner surface of said underwaist; and said control mechanism is fixed on said underwaist.

12. The device for controlling pet behavior according to claim 1, wherein a strap is detachably connected to said underwaist, a pulling force sensor is provided at a joint between said strap and said underwaist, and said pulling force sensor is in communication connection with said control mechanism.

13. The device for controlling pet behavior according to claim 1, wherein said device for controlling pet behavior also includes a signal generator in a communication connection with said control mechanism and is used for continuously transmitting a positioning signal within a preset specific range; said control mechanism is used for receiving said positioning signal, and is used for transmitting an electronic pulse signal of a preset specific voltage to said conductive posts when said positioning signal is not received.

14. A method for controlling pet behavior, wherein, based on said device for controlling pet behavior according to claim 1, comprising said following steps:
Step S100: said device for controlling pet behavior is worn on said pet's body through said wearing member and said conductive posts are in contact with said pet's body;
Step S200: said control mechanism transmits said electronic pulse signal of said preset specific voltage to said conductive posts, said electronic pulse signal is conducted to said pet's body via said conductive posts and is used for stimulating said pet's muscle to contract and tremor.

15. The method for controlling pet behavior, wherein, also comprising
Step S300: a signal generator of said device for controlling pet behavior sends a positioning signal within said preset specific range;
Step S400: said control mechanism determines whether said positioning signal is received;
Step S500: if said determination result is no, then said control mechanism outputs said electronic pulse signal with said preset specific voltage to said conductive posts so that said electronic pulse signal stimulates said pet's muscle to contract and tremor when said pet equipped with said device for controlling pet behavior moves outside said preset specific range.
